(19) United States
(12) Patent Application Publication
(10) Pub. No.: US 2025/0221885 A1
(43) Pub. Date: Jul. 10, 2025

(54) VIBRATING DEVICE

(71) Applicant: MysteryVibe Limited, Surrey (GB)

(72) Inventors: Robert Paul WEEKLY, Haslemere (GB); Soumyadip RAKSHIT, London (GB); Shanshan XU, London (GB); David Ian HEYWOOD, Surrey (GB)

(73) Assignee: MysteryVibe Limited, Surrey (GB)

(21) Appl. No.: 18/853,602

(22) PCT Filed: Apr. 7, 2023
(86) PCT No.: PCT/IB2023/053592

§ 371 Date: Oct. 2, 2024

Related U.S. Application Data
(63) Continuation-in-part of application No. 29/853,927, filed on Sep. 20, 2022, now Pat. No. D047190.
(60) Provisional application No. 63/329,312, filed on Apr. 8, 2022.

(30) Foreign Application Priority Data
May 30, 2022 (GB) 6211355
May 31, 2022 (EM) 009048200-0004

(51) Int. Cl. A61H 19/00; A61H 23/02

(52) U.S. Cl. CPC A61H 19/32; A61H 19/34; A61H 19/50; A61H 23/0254; A61H 2201/0192; A61H 2201/1215; A61H 2201/165; A61H 2201/1695; A61H 2201/5002; A61H 2201/5005; A61H 2201/5035; A61H 2201/5038; A61H 2201/5097; A61H 2205/087

(57) ABSTRACT

Wearable vibrating devices or sexual stimulation devices according to various embodiments are provided. In some embodiments, the device includes a loop through which a penis is inserted; at least one motor configured to generate vibration; an internal structure housing the at least one motor; and a housing enclosing the internal structure. In some embodiments, the device includes a main body having a first end and a second end, a first motor included in the main body to generate vibration; a first arm extending from the first end of the main body, a second motor included in the first arm to generate vibration; and a second arm extending from the second end of the main body, a third motor included in the second arm to generate vibration, wherein the main body, the first arm, and the second arm are shaped to form an open adjustable loop configured to receive a penis.

### CROSS-REFERENCE TO RELATED APPLICATIONS

This application includes a claim of priority under 35 U.S.C. § 119(e) to U.S. provisional patent application No. 63/329,312, filed Apr. 8, 2022, and a claim of priority under 35 U.S.C. § 120 to U.S. design patent application No. 29/853,927, filed Sep. 20, 2022, claiming priority under 35 U.S.C. § 119(a) and 172 to United Kingdom Design Application No. 6211355, filed May 30, 2022, and European Registered Community Design (RCD) Application No. 009048200-0004, filed May 31, 2022, the entirety of which is hereby incorporated by reference.

### FIELD OF INVENTION

The present invention relates to a vibrating device worn on a penis.

### BACKGROUND

Erectile Dysfunction (ED) is very common. Over 30 million men suffer from it in the U.S. alone. As a result, it can lead to an unfulfilled sex life; inability to get partner pregnant; loss of intimacy; strained relationship; depression; anxiety and low self-esteem. Currently the main solution for ED is phosphodiesterase (PDE)-5 inhibitors which are not suitable for everyone and can have adverse side effects. However, PDE-5 inhibitors are expensive as users need a new tablet every time they want to have intercourse. An alternate way to solve ED is to take PDE-5 inhibitor tablets such as Sildanafil and Tadanafil. However, not everyone is suitable to take these medicines and many experience adverse side effects. Additionally, many users are limited to a certain maximum number he can take it every week.

Therefore, there is a large unmet need to provide safer and cheaper solution for treatment of ED. Described herein is a device which offers an alternative solution for ED by delivering targeted vibration around a penis to help get erect and stay erect. The inventive device can be used as many times as a user wants once the user purchases the device, providing a much better user experience than PDE-5 inhibitors. The inventive device is a safe, non-medicinal alternative for ED treatment.

### SUMMARY OF THE INVENTION

The present disclosure provides a device. According to various embodiments of the present invention, the device includes a loop through which a penis is inserted; at least one motor configured to generate vibration; an internal structure housing the at least one motor; and a housing enclosing the internal structure.

In some embodiments, the loop is made of a flexible material and partly open. In some embodiments, the loop is substantially pentagon-shaped with one opening. In some embodiments, a size of the loop is adjustable to fit the penis according to a size of the penis. In some embodiments, the loop has a textured surface with a plurality of protrusions such that the inserted penis contacts the textured surface.

In some embodiments, the at least one motor includes a first motor provided at a first side of the loop and configured to provide vibration to a top side of the penis; a second motor provided at a second side of the loop and configured to provide vibration to a first bottom side of the penis; and a third motor provided at a third side of the loop and configured to provide vibration to a second bottom side of the penis. Different parts of the penis are stimulated simultaneously by the vibrations. In some embodiments, each of the first, second, and third motors is individually controllable.

In some embodiments, the device is configured to provide various preset vibration patterns such that a user can select a desired one of the preset vibration patterns. In some embodiments, the preset vibration patterns programmable by a user. In some embodiments, the device is controllable via an application running on a mobile device that is configured to communicate with the device wirelessly.

The present disclosure further provides a device. According to various embodiments of the present invention, the device includes a main body having a first end and a second end; a first arm extending from the first end of the main body; and a second arm extending from the second end of the main body. The main body, the first arm, and the second arm form an open adjustable loop configured to receive a penis.

In some embodiments, each of the first arm and the second arm is curved or angled.

In some embodiments, the main body is configured to contact a top portion of the penis. In some embodiments, the first arm is configured to contact a first bottom portion of the penis. In some embodiments, the second arm is configured to contact a second bottom portion of the penis.

In some embodiments, a gap is formed between the first arm and the second arm, a size of the gap changeable based on a size of the received penis. In some embodiments, at least the first arm and the second arm are flexible or deformable to accommodate the penis based on a size of the penis.

In some embodiments, each of the main body, the first arm, and the second arm has a motor configured to generate vibration. In some embodiments, intensity of the vibration of each motor is adjustable.

The present disclosure further provides a device. According to various embodiments of the present invention, the device includes a main body having a first end and a second end, a first motor included in the main body to generate vibration; a first arm extending from the first end of the main body, a second motor included in the first arm to generate vibration; and a second arm extending from the second end of the main body, a third motor included in the second arm to generate vibration. The main body, the first arm, and the second arm are shaped to form an open adjustable loop configured to receive a penis.

In some embodiments, the second motor is located at an end portion of the second arm that is farthest from the first end of the main body. In some embodiments, the third motor is located at an end portion of the third arm that is farthest from the second end of the main body.

In some embodiments, a gap is formed between the end portion of the second arm and the end portion of the third arm.

The present disclosure further provides a method of treating erectile dysfunction (ED) using a vibrating device. According to various embodiments of the present invention, the method includes placing the vibrating device on a head of a penis such that a 3600 stimulation is delivered around the head of the penis by a plurality of motors of the vibrating device; moving up the vibrating device along the penis to a base of the penis; and engaging in sexual intercourse with a partner while the vibrating device is worn at the base of the penis.

In some embodiments, the method further includes stretching two arms of the vibrating device outward prior to placing the vibrating device on the head of a penis.

In some embodiments, the vibrating device worn on the penis causes the vibrating device to stimulate the partner's labia during the sexual intercourse.

In some embodiments, the method further includes controlling a vibration pattern and/or a vibration intensity of the vibrating device while the vibrating device is worn on the penis via a app executed on a mobile device communicatively paired with the vibrating device.

The present disclosure further provides a method of erecting a penis or maintaining erection of a penis using a vibrating device. According to various embodiments of the present invention, the method includes placing the vibrating device on the penis glans or head of the penis to cause an erection or to maintain erection; and moving up the vibrating device along the penis to a base of the penis to maintain the erection.

In some embodiments, the method further includes engaging in sexual intercourse with a partner while the vibrating device is worn at the base of the penis, causing the device to stimulate the partner's labia during the intercourse.

In some embodiments, the method further includes turning on the vibrating device prior to placing the vibrating device on the penis.

In some embodiments, the method further includes controlling a vibration pattern and/or a vibration intensity of the vibrating device while the vibrating device is worn on the penis via an app executed on a mobile device communicatively paired with the vibrating device.

### BRIEF DESCRIPTION OF THE FIGURES

Exemplary embodiments are illustrated in referenced figures. It is intended that the embodiments and figures disclosed herein are to be considered illustrative rather than restrictive.

FIG. 1 shows a front perspective view of a wearable vibrating device in accordance with various embodiments of the present invention.

FIG. 2A shows a front view of a wearable vibrating device in accordance with various embodiments of the present invention.

FIG. 2B shows a partially exploded view of a wearable vibrating device in accordance with various embodiments of the present invention.

FIG. 3A shows a penis in a flaccid state and in an erect state.

FIG. 3B shows a penis wearing a vibrating device in accordance with various embodiments of the present invention in a flaccid state and in an erect state.

FIG. 4A is a front view of a wearable vibrating device in accordance with various embodiments of the present invention.

FIG. 4B is a right side view of a wearable vibrating device in accordance with various embodiments of the present invention.

FIG. 4C is a rear view of a wearable vibrating device in accordance with various embodiments of the present invention.

FIG. 4D is a left side view of a wearable vibrating device in accordance with various embodiments of the present invention.

FIG. 4E is a top view of a wearable vibrating device in accordance with various embodiments of the present invention.

FIG. 4F is a bottom perspective view of a wearable vibrating device in accordance with various embodiments of the present invention.

### DESCRIPTION OF THE INVENTION

All references cited herein are incorporated by reference in their entirety as though fully set forth. Unless defined otherwise, technical and scientific terms used herein have the same meaning as commonly understood by one of ordinary skill in the art to which this invention belongs.

The present invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

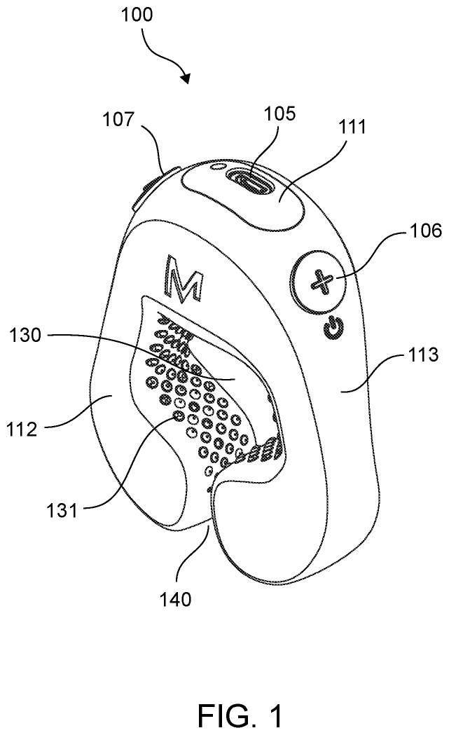

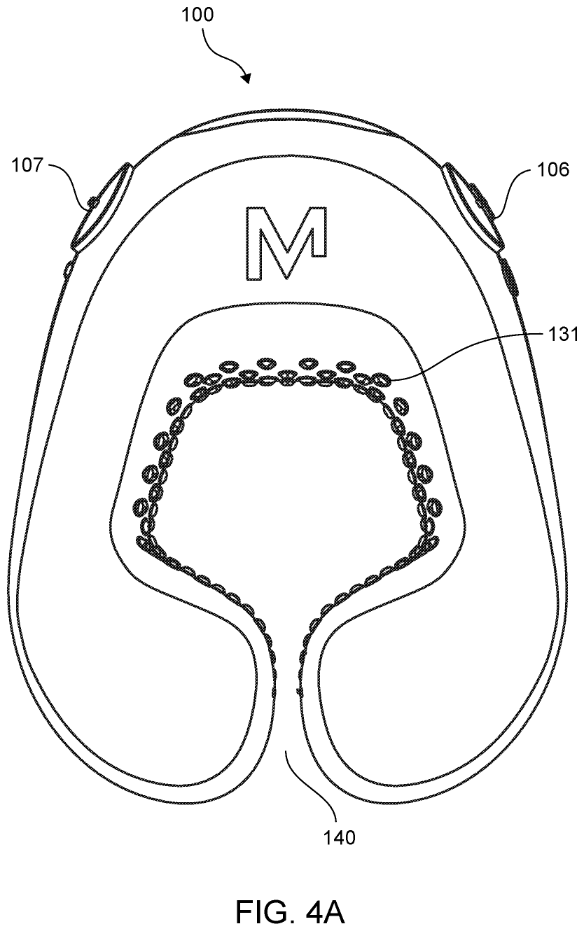

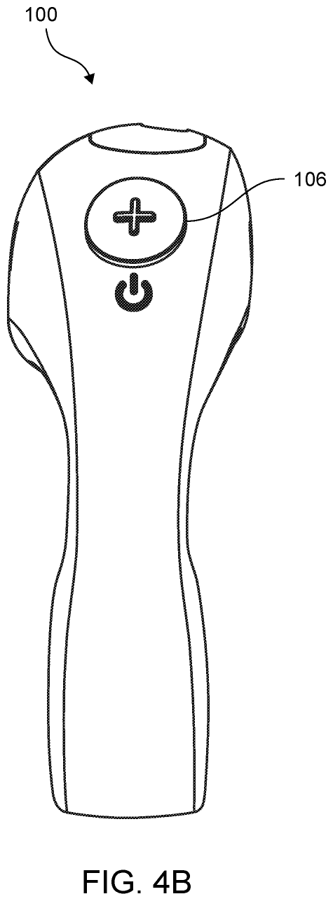

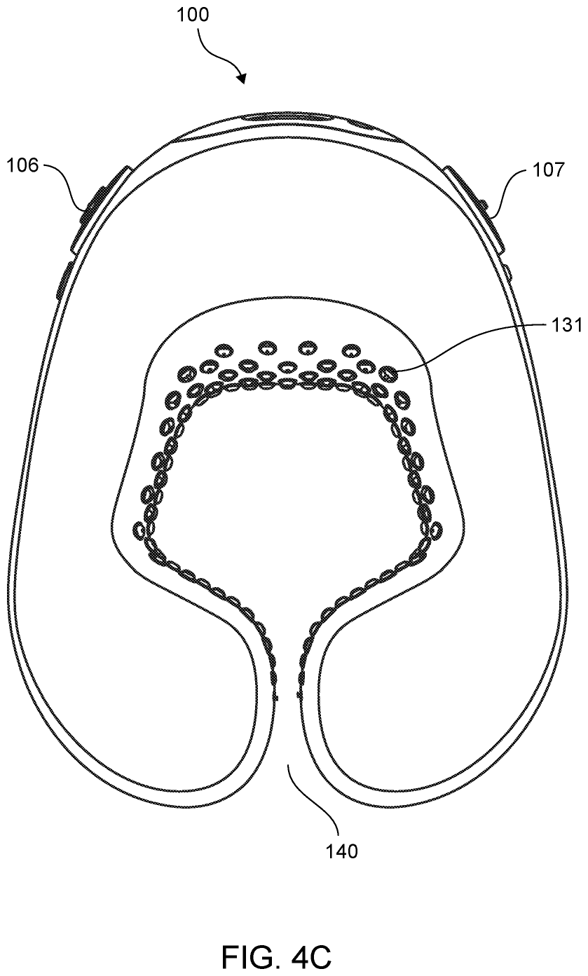

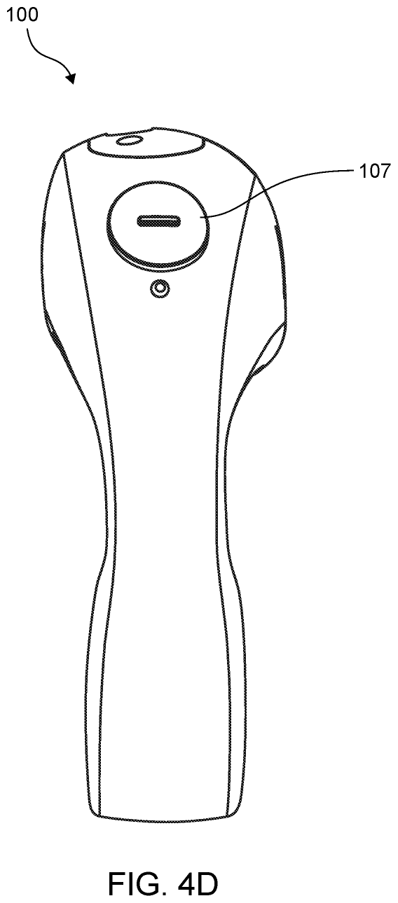

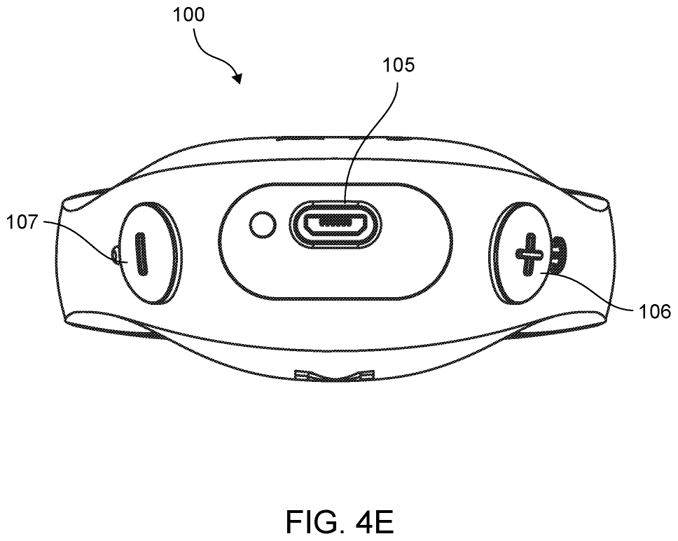

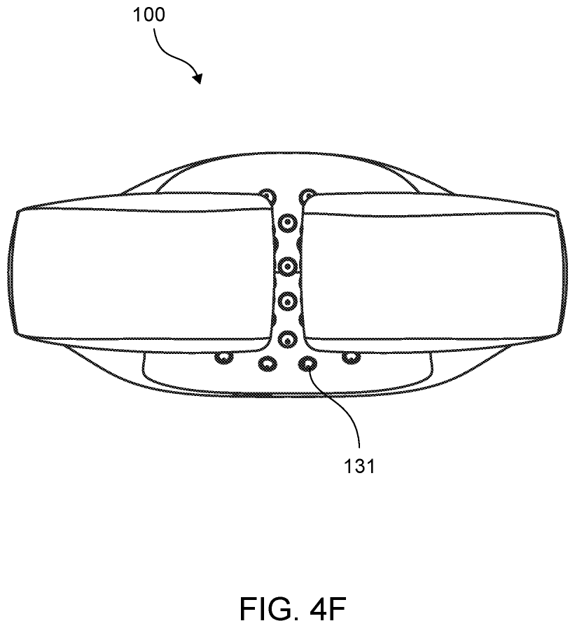

The various embodiments are directed to a wearable vibrating device 100 or sexual stimulation device, exemplified in FIG. 1. Referring to FIGS. 1, 4A, and 4C, in some embodiments, the vibrating device 100 is generally U-shaped. In some embodiments, the core structure of the vibrating device 100 is a dynamic inverted-U bendable wishbone chassis using bespoke pre-conditioned nylon material that enables flexibility with form recovery. In some embodiments, the vibrating device 100 has flexible design that comfortable adapts to a penis regardless of its size, increasing blood flow for maximum erection and extended performance.

Referring to FIGS. 1, 2A, 2B, and 4A-4F, in some embodiments, the vibrating device 100 has a main body 111 or top, a first arm 112 extending from a first side of the main body, and a second arm 113 extending from a second side of the main body. The first arm 112 and the second arm 113 are curved or angled such that a loop 130 is formed between the main body 111, first arm 112, and second arm 113. In some embodiments, the first arm 112 and second arm 113 are curved or angled at substantially middle portions thereof. That is, inner sides or surfaces of the main body 111, first arm 112, and second arm 113 forms the loop 130. In some embodiments, a textured surface 131 is provided to the loop 130 such that a penis inserted into the loop is in contact with the textured surface. For example, the textured surface 131 of the loop 130 has a plurality of protrusions formed on the surface.

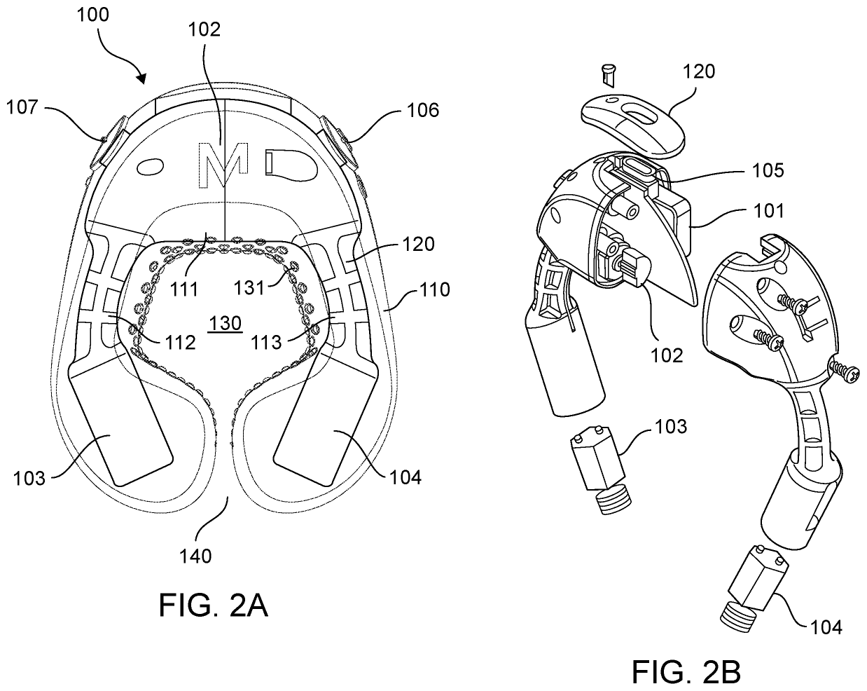

For example, the loop 130 is substantially circular. In some embodiments, the loop 130 is substantially pentagon-shaped, a substantially linear or slightly curved surface provided by the inner side of the main body 111 being extended to two curved surfaces provided by inner sides of the first arm 112 and second arm 113, thus forming a pentagon shape, as exemplified in FIG. 2A. However, the shape of the loop 130 is not limited thereto and the loop may have any shape that can accommodate a penis therein. Moreover, the loop 130 is not completely closed or is partly open such that the size of the loop can be adjusted by flexibility of the first arm 112 and second arm 113. For example, the shape of the loop 130 can be adjusted with hands.

The end portions of the first arm 112 and the second arm 113 are not in contact with each other such that a gap 140 is formed between the end portion of the first arm and the end portion of the second arm. As shown in FIGS. 1, 2A, 4A, 4C, and 4F, the gap 140 is specifically located at the bottom of the vibrating device 100 opposite the main body 111 or top of the device so that when the vibrating device is placed on the penis, it allows semen to be ejaculated, a key requirement for user's wanting to get their partner pregnant.

The internal structure 120 of the vibrating device 100 houses electronics, battery 101 and vibration motors 102, 103, 104, as exemplified in FIG. 2B. For example, the internal structure 120 is protected by a housing 110 enclosing the internal structure, as shown in FIG. 2A. For example, the housing 110 is made of silicone. In some embodiments, the vibrating device 100 is waterproof, and thus, fully submersible making it very easy to clean with a toy cleaner or soap and water. The vibrating device 100 is designed to stretch to create a gap at the widest part of up to 2 inches, accommodating over 90% of erect penises. The vibrating device 100 is designed to revert back to its standard shape irrespective of the number of times it is stretched. This allows the vibrating device 100 to be stretched to create a gap big enough to easily wear it on the penis, and then come back to its tight shape to fit snug around the penis and hold the erection.

Referring to FIGS. 2A and 2B, the vibrating device 100 includes vibration motors, for example three motors: a first motor 102 at the top of the device or in the main body 111, a second motor 103 in the first arm 112 and a third motor 104 in the second arm 113 of the vibrating device. However, the number of motors is not limited to three, and the number of motors may be less or greater than three. Thus, the vibrating device 100 vibrates all around the penis when the device is worn around the penis. At the same time, the vibration caused by the multiple motors 102, 103, 104 also stimulate the clitoris and vulva of a partner.

The vibrating device 100 further includes a rechargeable battery 101 that powers the device in the main body 111. For example, the battery 101 is a built-in lithium-ion battery. In some embodiments, the battery 101 is rechargeable via a port 105 of the device 100 and operably coupled to a circuit board and/or motors 102, 103, 104. In some embodiments, the battery 101 is recharged wirelessly. For example, the port 105 is located at the top of the device 100 or at the main body 111, as shown in FIGS. 1 and 2B. For example, the port 105 is a Universal Serial Bus (USB) port including micro USB, USB-A, USB-B, and USB-C Port Types. The charged battery 101 provides power to operate the motors 102, 103, 104. In some embodiments, the vibrating device 100 further includes a wireless communication device for wireless communication with a remote controller or a mobile device. For example, the wireless communication includes BLUETOOTH® connection.

In some embodiments, the vibrating device 100 further includes a switch. The vibrating device 100 has one, two, or multiple switches based on the design. For example, the vibrating device 100 is provided with two input buttons 106, 107 on the upper surface, as shown in FIGS. 1, 2A, and 4A-4E. These input buttons 106, 107 provide functions such as power on/off, vibration pattern navigation, intensity adjustment and BLUETOOTH® pairing. For example, double pressing both buttons 106, 107 causes the device 100 to cycle through the vibrations or patterns and single pressing both buttons 106, 107 causes the device 100 to change the intensity. Further, for example, the device 100 is turned on/off in response to pressing and holding a designated button 106 or 107 for at least a preset duration, i.e., 1, 2, or 3 seconds. In some embodiments, the vibrating device 100 is paired with a mobile device to be controlled by the mobile device. For example, a mobile application or app, i.e., a computer program or software application, is run on the mobile device to control the vibrating device 100 via the mobile application. In some embodiments, the vibrating device 100 works perfectly stand-alone without the app.

In some embodiments, the vibrating device 100 has changeable preset settings. For example, the settings include multiple vibration patterns and multiple vibration intensities to select. In some embodiments, the app provides different vibration patterns to be selected from a pre-made list. New lists can also be made from scratch by a user via the app so that the vibrations can be customized to provide optimal results for the user. For example, the number of settings for vibration intensity is about 10, about 15, or about 20.

In some embodiments, each of the three motors 102, 103, 104 can be individually controlled. Further, various vibration patterns generated by the motors 102, 103, 104 can be selected or set by a user. For example, a vibration pattern can comprise of set minutes (for example 1, 2, 3, 4, or 5 minutes) of unique pattern sequencing of the motors before repeating. Vibration patterns are, for example, either pre-programmed on the circuit board of the vibrating device 100 or by using the user's mobile device or smart phone to remotely control the motors 102, 103, 104.

Users can create their own vibration patterns utilising the app available for the vibrating device 100. For example, the app is available on Google Play and Apple App stores. Once created, these vibration patterns can be loaded onto the vibrating device 100 for use in standalone operation mode.

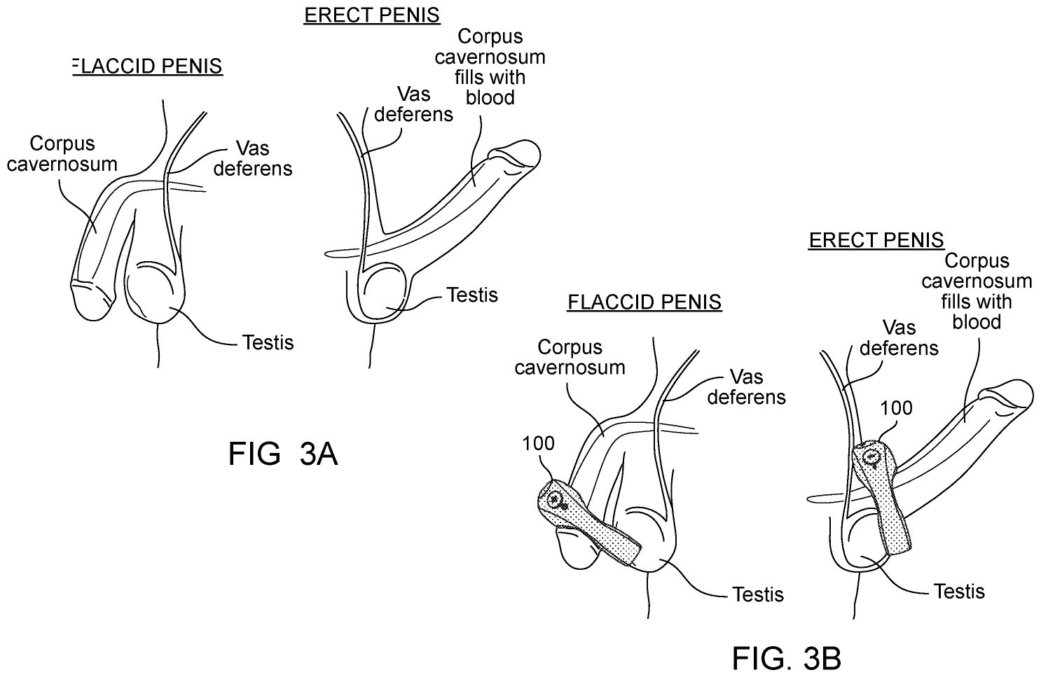

The vibrating device 100 is worn on a penis and provides stimulations to various parts of the penis, as exemplified in FIG. 3B. According to some embodiments, at least two simultaneous stimulations are provided by the vibrating device 100 to different parts of the penis. For example, three simultaneous stimulations generated by the three motors 102, 103, 104 are provided on the top and bottom of the penis by the vibrating device 100.

Referring to FIGS. 3A and 3B, in some embodiments, the vibrating device 100 is used in the following steps:

The device 100 is first worn on the penis glans (head of the penis) to deliver a 3600 stimulation around it which is the most sensitive part of the penis, for example, as shown in the left panel of FIG. 3B. This leads to rapid arousal and increased blood flow to the penis resulting in an erection.

The device 100 is then moved up the penis shaft to sit at the base of the penis, for example, as shown in the right panel of FIG. 3B. In some embodiments, the device 100 is positioned such that testicles are situated above the device. The device 100 in contact with the base of the penis can maintain the erection by constricting the blood flow and continue to deliver 3600 stimulations to maintain arousal.

Finally, the device 100 is used during intercourse to stimulate the partner's labia to assist in their arousal and orgasm. That is, the user wearing the vibrating device 100 at the base of the penis is engaged in the sexual intercourse with his partner. In some embodiments, the device 100 is also used as a nipple stimulator.

In some embodiments, the device 100 is turned on before putting it on the penis. In some embodiments, the device 100 turned on after putting it on the penis. In some embodiments, water-based lubrication is applied to the device 100, penis, or both the device and penis. In some embodiments, the arms 112, 113 are stretched and open to slide the device 100 on. In some embodiments, the device 100 is controlled via the app or remote control while the device is worn.

Further referring to FIGS. 3A and 3B, in some embodiments, a method of treating erectile dysfunction (ED) using the vibrating device 100 includes wearing the device worn on the penis glans or head of the penis (for rapid arousal and increase of blood flow to the penis to result in an erection), as exemplified in the left panel of FIG. 3B; moving up the device along the penis to the base of the penis, as exemplified in the right panel of FIG. 3B (to maintain the erection by constricting the blood flow and to maintain arousal); and engaging in sexual intercourse with a partner while the device is worn at the base of the penis, causing the device to stimulate the partner's labia during the intercourse (to assist in the partner's arousal and orgasm).

Further referring to FIGS. 3A and 3B, in some embodiments, a method of erecting a penis or maintaining erection of a penis using the vibrating device 100 includes wearing the device worn on the penis glans or head of the penis (for rapid arousal and increase of blood flow to the penis to result in an erection or to maintain erection), as exemplified in the left panel of FIG. 3B; moving up the device along the penis to the base of the penis, as exemplified in the right panel of FIG. 3B (to maintain the erection by constricting the blood flow and to maintain arousal); and engaging in sexual intercourse with a partner while the device is worn at the base of the penis, causing the device to stimulate the partner's labia during the intercourse (to assist in the partner's arousal and orgasm).

A major challenge in creating devices to assist in erections is that the penis varies greatly in size between flaccid and erect states. That is, both the length and circumference of penises are different for different men. Therefore, for the device 100 to be effective in arousing the penis and constricting the blood to maintain erection, it needs to fit tightly around the penis. At the same time, the vibrating device 100 needs to be easy to wear and comfortable to use.

Moreover, if it is to allow ejaculation, the device 100 cannot constrict the bottom part of the penis and if it is also needed to stimulate the partner's labia during intercourse, then the device needs to be incredibly versatile. The vibrating device 100 should be flexible on both sides so that it can be easily stretched to be put on various penis shapes and sizes.

Thus, the vibrating device 100 should retain its tight grip, over thousands of times that it is stretched. The vibrating device 100 should also have multiple strong vibration motors that can arouse the penis, continue to keep the penis aroused, and simultaneously stimulate the partner's labia.

The vibrating device 100 is designed to precisely solve the above-identified issues, delivering precise vibrations through its multiple, for example three, motors in a flexible structure. The vibrating device 100 is constructed and configured to stretch to fit different penis shapes and sizes, delivering 3600 vibrations all around the penis head to create an erection. Once the penis is erect, by being placed at the base of the penis, the vibrating device 100 continues to deliver 360° vibrations all around the base of the penis while at the same time constricting the blood flow to maintain the erection. The gap formed at the bottom of the device 100 allows the semen to be ejaculated, while delivering 360° vibrations to the partner's labia during intercourse.

The above described features of the vibrating device 100 are achieved by making the internal structure incredibly flexible through a combination of plastics and materials, for example resin, and a certain amount of moisture infusion.

According to various embodiments of the present disclosure, a device includes a loop through which a penis is inserted; at least one motor configured to generate vibration; an internal structure housing the at least one motor; and a housing enclosing the internal structure.

According to some embodiments of the present disclosure, the loop is made of a flexible material and partly open. In some embodiments, the loop is substantially pentagon-shaped with one opening. In some embodiments, a size of the loop is adjustable to fit the penis according to a size of the penis. In some embodiments, the loop has a textured surface with a plurality of protrusions such that the inserted penis contacts the textured surface. In some embodiments, the at least one motor includes a first motor provided at a first side of the loop and configured to provide vibration to a top side of the penis; a second motor provided at a second side of the loop and configured to provide vibration to a first bottom side of the penis; and a third motor provided at a third side of the loop and configured to provide vibration to a second bottom side of the penis. In one aspect of the present disclosure, different parts of the penis are stimulated simultaneously by the vibrations. In some embodiments, each of the first, second, and third motors is individually controllable. In some embodiments, the device is configured to provide various preset vibration patterns such that a user can select a desired one of the preset vibration patterns. In some embodiments, the preset vibration patterns programmable by a user. In some embodiments, the device is controllable via an application running on a mobile device that is configured to communicate with the device wirelessly.

According to various embodiments of the present disclosure, a device includes a main body having a first end and a second end; a first arm extending from the first end of the main body; and a second arm extending from the second end of the main body, wherein the main body, the first arm, and the second arm form an open adjustable loop configured to receive a penis.

According to some embodiments of the present disclosure, each of the first arm and the second arm is curved or angled. In some embodiments, the main body is configured to contact a top portion of the penis; the first arm is configured to contact a first bottom portion of the penis; and the second arm is configured to contact a second bottom portion of the penis. In some embodiments, a gap is formed between the first arm and the second arm, a size of the gap changeable based on a size of the received penis. In some embodiments, at least the first arm and the second arm are flexible or deformable to accommodate the penis based on a size of the penis. In some embodiments, each of the main body, the first arm, and the second arm has a motor configured to generate vibration. In some embodiments, intensity of the vibration of each motor is adjustable.

According to various embodiments of the present disclosure, a device includes a main body having a first end and a second end, a first motor included in the main body to generate vibration; a first arm extending from the first end of the main body, a second motor included in the first arm to generate vibration; and a second arm extending from the second end of the main body, a third motor included in the second arm to generate vibration, wherein the main body, the first arm, and the second arm are shaped to form an open adjustable loop configured to receive a penis.

According to some embodiments of the present disclosure, the second motor is located at an end portion of the second arm that is farthest from the first end of the main body; and the third motor is located at an end portion of the third arm that is farthest from the second end of the main body. In some embodiments, a gap is formed between the end portion of the second arm and the end portion of the third arm.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

The term “coupled” is defined as connected, whether directly or indirectly through intervening components, and is not necessarily limited to physical connections. The connection can be such that the objects are permanently connected or releasably connected. The term “substantially” is defined to be conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

1. A device comprising:
a loop through which a penis is inserted;
at least one motor configured to generate vibration;
an internal structure housing the at least one motor; and
a housing enclosing the internal structure.

2. The device according to claim 1, wherein the loop is made of a flexible material and partly open.

3. The device according to claim 1, wherein the loop is substantially pentagon-shaped with one opening.

4. The device according to claim 1, wherein a size of the loop is adjustable to fit the penis according to a size of the penis.

5. The device according to claim 1, wherein the loop has a textured surface with a plurality of protrusions such that the inserted penis contacts the textured surface.

6. The device according to claim 1, wherein the at least one motor comprises:
a first motor provided at a first side of the loop and configured to provide vibration to a top side of the penis;
a second motor provided at a second side of the loop and configured to provide vibration to a first bottom side of the penis; and
a third motor provided at a third side of the loop and configured to provide vibration to a second bottom side of the penis,
such that different parts of the penis are stimulated simultaneously by the vibrations.

7. The device according to claim 6, wherein each of the first, second, and third motors is individually controllable.

8. The device according to claim 1, wherein the device is configured to provide various preset vibration patterns such that a user can select a desired one of the preset vibration patterns.

9. The device according to claim 8, wherein the preset vibration patterns programmable by a user.

10. The device according to claim 1, wherein the device is controllable via an application running on a mobile device that is configured to communicate with the device wirelessly.

11. A device comprising:
a main body having a first end and a second end;
a first arm extending from the first end of the main body; and
a second arm extending from the second end of the main body,
wherein the main body, the first arm, and the second arm form an open adjustable loop configured to receive a penis.

12. The device according to claim 11, wherein each of the first arm and the second arm is curved or angled.

13. The device according to claim 12, wherein:
the main body is configured to contact a top portion of the penis;
the first arm is configured to contact a first bottom portion of the penis; and
the second arm is configured to contact a second bottom portion of the penis.

14. The device according to claim 11, wherein a gap is formed between the first arm and the second arm, a size of the gap changeable based on a size of the received penis.

15. The device according to claim 11, wherein at least the first arm and the second arm are flexible or deformable to accommodate the penis based on a size of the penis.

16. The device according to claim 15, wherein each of the main body, the first arm, and the second arm has a motor configured to generate vibration.

17. The device according to claim 16, wherein intensity of the vibration of each motor is adjustable.

18. A device comprising:
a main body having a first end and a second end, a first motor included in the main body to generate vibration;
a first arm extending from the first end of the main body, a second motor included in the first arm to generate vibration; and
a second arm extending from the second end of the main body, a third motor included in the second arm to generate vibration,
wherein the main body, the first arm, and the second arm are shaped to form an open adjustable loop configured to receive a penis.

19. The device according to claim 18, wherein:
the second motor is located at an end portion of the second arm that is farthest from the first end of the main body; and
the third motor is located at an end portion of the third arm that is farthest from the second end of the main body.

20. The device according to claim 19, wherein a gap is formed between the end portion of the second arm and the end portion of the third arm.

21. A method of treating erectile dysfunction (ED) using the device of claim 1, the method comprising:
placing the device on a head of a penis such that a 360° stimulation is delivered around the head of the penis by the at least one motor;
moving up the device along the penis to a base of the penis; and
engaging in sexual intercourse with a partner while the device is worn at the base of the penis.

22. The method of claim 21, further comprising stretching two arms of the device outward prior to placing the device on the head of the penis.

23. The method of claim 21, wherein the device worn on the penis causes the device to stimulate the partner's labia during the sexual intercourse.

24. The method of claim 21, further comprising controlling a vibration pattern and/or a vibration intensity of the device while the device is worn on the penis via an app executed on a mobile device communicatively paired with the device.

25. A method of erecting a penis or maintaining erection of a penis using the device of claim 1, the method comprising:
placing the device on the penis glans or head of the penis to cause an erection or to maintain erection; and
moving up the device along the penis to a base of the penis to maintain the erection.

26. The method of claim 25, further comprising engaging in sexual intercourse with a partner while the device is worn at the base of the penis, causing the device to stimulate the partner's labia during the sexual intercourse.

27. The method of claim 25, further comprising turning on the device prior to placing the device on the penis.

28. The method of claim 25, further comprising controlling a vibration pattern and/or a vibration intensity of the device while the device is worn on the penis via an app executed on a mobile device communicatively paired with the device.
